(19) United States
(12) Patent Application Publication
(10) Pub. No.: US 2019/0228191 A1
(43) Pub. Date: Jul. 25, 2019

(54) DIGITAL INFORMATION CARDS AND METHODS FOR THEIR USE

(71) Applicant: Doron Aviad, Tel Aviv (IL)

(72) Inventor: Doron Aviad, Tel Aviv (IL)

(21) Appl. No.: 16/253,318

(22) Filed: Jan. 22, 2019

Related U.S. Application Data
(60) Provisional application No. 62/620,028, filed on Jan. 22, 2018.

(51) Int. Cl. G06K 7/08; G06K 7/10; G06K 7/14

(52) U.S. Cl. CPC G06K 7/082; G06K 7/1404; G06K 7/10297

(57) ABSTRACT

Methods and systems are provided for transferring data between digital cards and other physical apparatus, and the devices reading these digital cards. The reading devices include card readers, such as computers, including smart phones,

### CROSS REFERENCES TO RELATED APPLICATIONS

This application is related to and claims priority from commonly owned U.S. Provisional Patent Application Ser. No. 62/620,028, entitled: Digital Information Cards and Methods for Their Use, filed on Jan. 22, 2018, the disclosure of which is incorporated by reference in its entirety herein.

### TECHNICAL FIELD

The present invention is directed to business cards and other informational cards, as well as access cards.

### BACKGROUND

Business cards are commonly passed between people at gatherings, meetings and other events. These cards are printed on cardboard or other paper or plastic stock, and typically include the holder's name, affiliation, and contact information. The information from these cards needs to be entered into an electronic file, and typically, before this is done, the cards become lost or forgotten.

### SUMMARY

The present invention provides methods and systems for creating, sharing and managing digital cards, which include readable media in order to access and transfer data between computers, computerized devices and the entities associated therewith.

The present invention also provides methods and systems for transferring data between digital cards and other physical apparatus, and the devices reading these digital cards. The reading devices include card readers, such as computers, including smart phones,

Embodiments of the invention are directed to a method for transferring data to a computerized location (e.g., a computerized device, computer, server or the like, for example, over a communications network). The method comprises: providing a physical apparatus including readable media including a readable indicator, the indicator associated with a system destination; in response to the readable media of the physical apparatus being read, receiving a request for data at the system destination associated with the indicator; obtaining data for the request by accessing an electronic representation of the physical apparatus associated with the indicator at the system destination; and, transmitting the data of the electronic representation to a request destination provided in the system request.

Optionally, the method is such that the physical apparatus includes a card, and typically the system includes multiple cards for administration thereof.

Optionally, the method is such that the readable indicator includes a uniform resource locator (URL).

Optionally, the method is such that the readable indicator includes the system request.

Optionally, the method is such that the system destination includes a computer configured for administering the card.

Optionally, the method is such that the request destination includes a device which reads the card.

Optionally, the method is such that the device includes a smart phone and the data of the electronic representation transmitted to the device displays on the device such that the user of the device can cause the displayed data to be stored in the device, or at another location linked to the device.

Optionally, the method is such that the request destination is a location different than the device which read the card.

Optionally, the method is such that the electronic representation of the card is stored in storage media associated with the computer configured for administering the card.

Optionally, the method is such that the URL maps to a computer configured for administering the physical apparatus, the computer defining the system destination.

Optionally, the method is such that the electronic representation of the physical apparatus includes data and functionalities.

Optionally, the method is such that the readable media of the physical apparatus is read by at least one of near field communications (NFC), radio frequency (RF), magnetics and light.

Optionally, the method is such that the readable media includes one or more of chips, magnetic components, Radio Frequency chips, and light activatable chips.

Optionally, the method is such that the readable media includes the indicator and/or the system request coded therein.

Optionally, the method additionally comprises: receiving input of data including data and/or functionalities for creating the electronic representation of the physical media.

Optionally, the method is such that the obtaining the data and transmitting the data are performed automatically.

Embodiments of the invention are directed to a system for transferring data to a computerized location. The system comprises: a card including readable media including a readable indicator, the indicator associated with a system destination; and, a computer defining the system destination for administering the card. The computer, which may be a processor, server, or the like, is configured for: receiving a request for data at the system destination associated with the indicator, in response to the readable media of the card being read; obtaining data for the request by accessing an electronic representation of the card associated with the indicator at the system destination; and, transmitting the data of the electronic representation to a request destination provided in the system request.

Optionally, the system is such that the readable indicator includes a uniform resource locator (URL) and/or a request coded into the readable media of the card.

Optionally, the system is such that the readable media of the card is read by at least one of near field communications (NFC), radio frequency (RF), magnetics and light.

Optionally, the system is such that the readable media includes one or more of chips, magnetic components, Radio Frequency chips, and light activatable chips.

This document references terms that are used consistently or interchangeably herein. These terms, including variations thereof, are as follows.

The terms “click”, “clicks”, “click on”, “clicks on”, “activates”, and “activation”, involves the activation of a computer pointing apparatus, such as a device commonly known as a mouse, or a touch, swipe, contact, or the like on a touch screen, on a location on a computer screen display, including screen displays of tablets and mobile telephones. The screen displays are activatable, for example, by an activatable icon, that causes an action of the various software and or hardware, including that for executing applications and supporting the computer screen display.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “client” is an application that runs on a computer, workstation or the like and relies on a server to perform some of its operations or functionality.

“n” and “nth” refer to the last member of a varying or potentially infinite series.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2A is an illustration of a digital card in accordance with embodiments of the disclosed subject matter;

FIG. 2B is an illustration of the digital card of FIG. 2A as a screen display on a touchscreen of a computing device of a user;

FIG. 3 is a diagram of the architecture of the card server of FIG. 1 and the system thereof;

FIG. 4 is a flow diagram of a process in accordance with embodiments of the present invention;

FIGS. 5A-5D are screen displays of the digital card in accordance with embodiments of the invention which display on devices, such as the touch screen of a smartphone of the user/recipient of the digital card;

FIG. 6 is a diagram of an exemplary environment for a smart conference system in which embodiments of the disclosed subject matter are performed;

FIG. 7 is a diagram of a card used in the smart conference system of FIG. 6;

FIG. 8A is a screen diagram of a landing web page of the master conference server of FIG. 6;

FIG. 8B is a screen diagram of a web page for a conference hosted by the master conference server of FIG. 6;

FIG. 8C is a web page onto which data for a conference is inputted; and,

FIG. 9 is another screen diagram of a web page for a conference hosted by the master conference server of FIG. 6.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention provides methods and systems for creating, sharing and managing digital cards, which include readable data. This data is typically readable when a card and a device, capable of reading the card, are within a predetermined distance of each other, or brought into a physical contact with each other. When the digital card disclosed herein is read, the digital card maps to an electronic representation of the card, in a storage media, such as a server, computer or other electronic machine. The electronic representation of the card includes functionalities for use on the device which read the card, when the digital card presents on the display screen, e.g., touch screen of the reading or displaying device, which is for example, a smart phone, tablet computer, ipad®, desktop computer, and the like. The functionalities of the digital card, which correspond to the electronic representation of the card, are operable on the reading device and/or a displaying device, via a respective Application Programming interface (API) on the respective device.

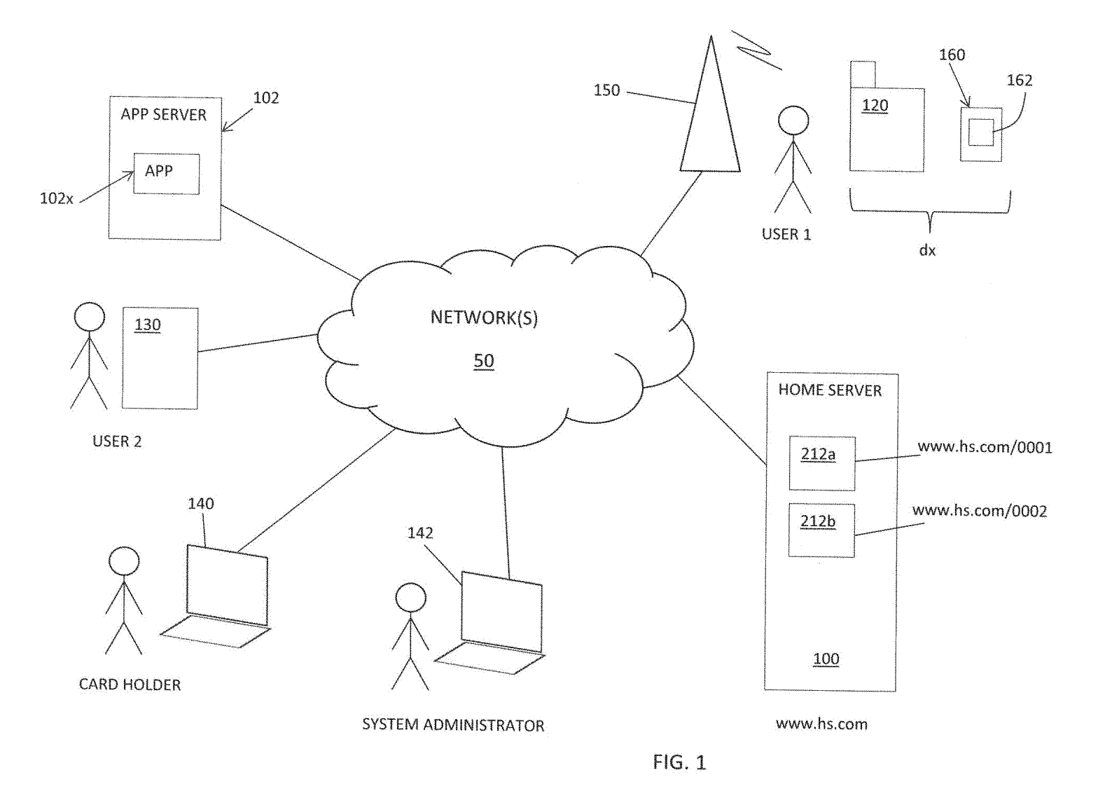

Reference is now made to FIG. 1, which shows an exemplary operating environment, including a network 50, to which is linked a home server (CS) 100, also known as a main server. The home server 100 also defines a system 100′, either alone or with other, computers, including servers, components, and applications, e.g., client applications, associated with either the home server 100, as detailed below. For explanation purposes, the home server 100 has a URL of www.hs.com. The network 50 is, for example, a communications network, such as a Local Area Network (LAN), or a Wide Area Network (WAN), including public networks such as the Internet. As shown in FIG. 1, the network 50 is either a single network or a combination of networks and/or multiple networks, including also (in addition to the aforementioned communications networks such as the Internet), for example, cellular networks. “Linked” as used herein includes both wired or wireless links, either direct or indirect, and placing the computers, including, servers, components and the like, in electronic and/or data communications with each other.

The various servers, computers and devices linked to the network 50, in addition to the home server 100, include, for example, an application server 102, which stores and makes accessible, for example, by downloading, the application (APP) 102x of the present invention. This application 102x may be obtained by entities, represented for example, by computers, e.g., device such as a smartphone of Users, such as the laptop/ipad®, desktop computer or smartphone, represented by element 130, of User2, and other computers, mobile devices and other computer devices that link to the network(s) 50. The application 102x includes executable software, and graphical user interfaces (GUI), through which the disclosed processes and functionalities associated therewith are implemented. The application 102x includes code segments which map to the system 100′ of the home server 100, for allowing user computer/user computerized device interaction with the system 100′. There are also code segments, including self-executing instructions, for performing other processes and functions as detailed herein.

Other entities, including the cardholder, represented by computer 140, and the system administrator, represented by the computer 142 link to the network(s) 50. The system administrator 142 has control over all issued cards (as administered by the system 100′) as well as the templates used to make the cards and their corresponding electronic representations (of each of the cards 160) in the system 100′ databases 212. The system administrator 142 can add and remove privileges, data, functionalities and permissions, such as entries and access, from any card associated with the system 100′, which may or may not have been issued to cardholders 140.

A card reading device (reader) 120, such as a smartphone, which links to the network(s) 50 via a cellular tower 150, reads the disclosed digital card 160, or other physical apparatus, when the digital card 160 is within a predetermined distance dx, or in contact with the smartphone 120. The card 160 includes readable media 162, which is read by technologies such as near field communications (NFC), radio frequency (RF), magnetic, and light readers, and the like. The readable media 162, includes chips, semiconductor chips, magnetic components, RF chips, light activatable chips, and the like, depending on the readable media sought to be used.

The readable media 162, for example, once read (by the reading device, e.g., smartphone 120), causes the reading device, e.g., the smart phone 120, to access the home server 100 and its system 100′, in order to load the digital card 160 data and functionalities onto the smartphone 120, so as to display 160x on the touch screen of the smartphone 120, with the functionalities of the digital card 160 being operational on the smart phone 120, as shown, for example, in FIG.

2B.

For example, on the card 160, the readable media 162 includes a readable indicator, such as an embedded or coded URL, which is unique for that individual card (known as a “unique URL”), and, for example, also a request for various actions by the system 100′, known for example, as a system request. When the reader, e.g., the smartphone 120 reads the card, the now activated smartphone 120 (having read the unique URL from the card 160), maps to the home server 100, so as to link the smartphone 120 to the electronic representation of the digital card for the read URL (from the readable media 162 of the card 160). For example, when the digital card 160 is read, the smartphone 120 links to the corresponding URL www.hs.com/0001 of the home server 100. The URL www.hs.com/0001 is associated with the electronic representation of the card 212a (stored in a database 212 of the system 100′ of the home server 100). The data and functionalities for the electronic representation of the card 212a corresponding to digital card 160, are transmitted to the smartphone 120 and displayed as a screen display 160x on the touchscreen of the recipient's reading device, e.g., smart phone 120, in a manner corresponding to that of the digital card 160, with all functionalities of the digital card 160 of the screen display 160x being operable, via the respective APIs of the smartphone 120.

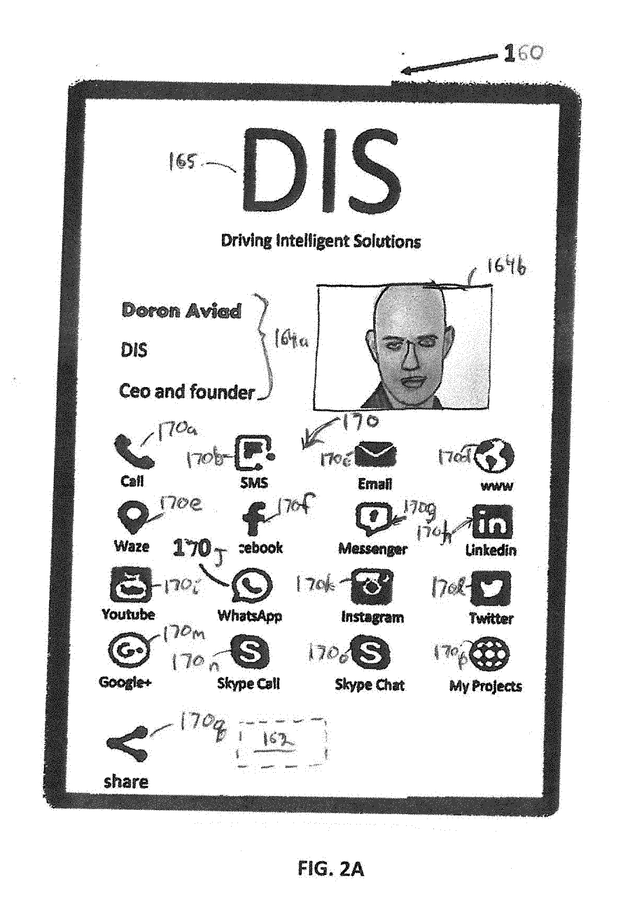

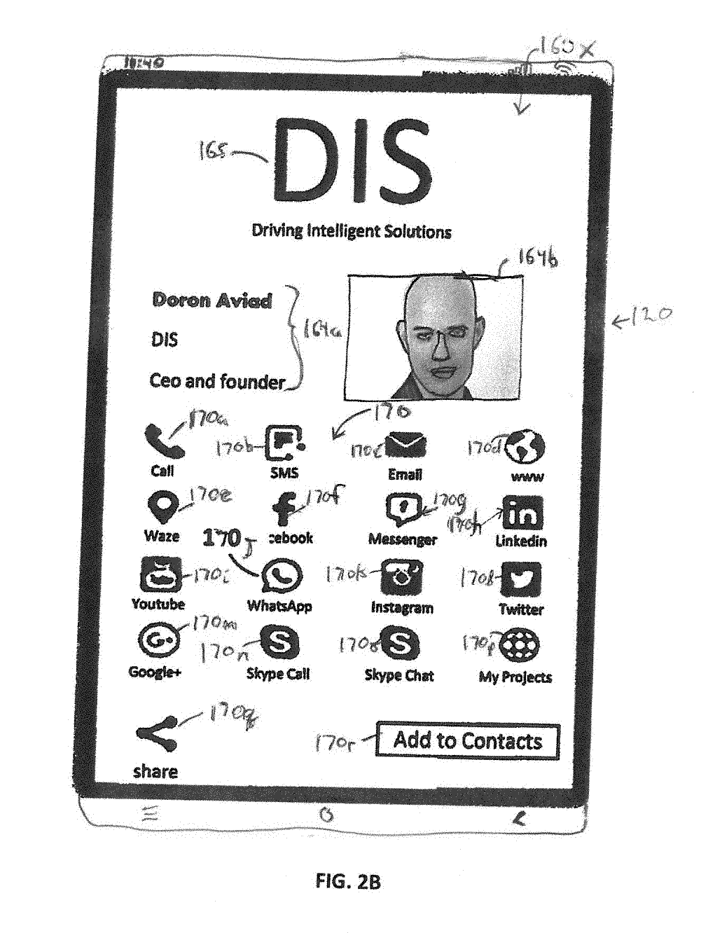

FIG. 2A shows an example digital card 160. The card 160 is associated with the URL www.hs.com/0001, associated with the home server 100 and system 100′, and is stored in a database 212 in the home server 100 as an electronic representation 212a of the card 160. The card 160 includes information and data about the subject of the card 164a and an image of the holder 164b, the affiliation of the holder 165, e.g., DIS Driving Intelligent Solutions, and various functionalities 170. These functionalities include, for example, actions such as CALL, represented by icon 170a, SMS (short message service) 170b, email 170c, web access 170d, Waze™ (get directions to Doron Aviad's location 170e), access Doron Aviad's Facebook Page 170f, messenger Doron Aviad 170g, access Doron Aviad's Linkedin Page 170h, see a video Doron Aviad recommends 170i, send Doron Aviad a WhatsApp message 170j, access Doron Aviad's Instagram Page 170k, send a Twitter tweet to Doron Aviad 170l, join a Google discussion with Doron Aviad 170m, Skype Call Doron Aviad 170n, Skype Chat with Doron Aviad 170o, Perform projects with Doron Aviad 170p (including seeing work samples), and share a digital media item with Doron Aviad 170q. The card 160 also includes the readable media 162 (shown in a broken line box as it is, for example, embedded in the card 160), which, for example, includes a machine readable unique URL.

The various data and functionalities 170a-170q are part of a template of the system 100′. The cardholder 140 (and/or system administrator 142) inputs data, which includes selecting the desired functionalities and links and/or data associated therewith, into the template (from the system 100′, e.g., in a database of templates), to create his personalized or customized card, e.g., card 160. This inputted data and selected functionalities is also used as the electronic representation 212a of the card 160 in the system 100′.

In FIG. 2B, the card, once read by the device, e.g., smartphone 120, is shown as a screen display 160x on the touch screen of the smartphone 120. This screen display 160x is similar to that of the card 160, but further includes an activatable box or button 170r (as part of the software that facilitates the screen display 160x, from either the APP 102x or the system 100′), that when activated, adds the cardholder, Doron Aviad, to the contact list of the device 120, for example, by downloading the data. Also, the data can be sent from the device 120 to another destination linked to the device, for example, over the network(s) 50. The underlying programs for operating the functionalities are operable (via APIs) on the device 120, such that when the functionality's icon is activated, e.g., by a touch, swipe or other contact on the touchscreen of the smartphone 120, they perform their designated task. For example, when icon 170j for WhatsApp is activated, the user of the smartphone 120 can create and then transmit a WhatsApp message to the designated communication device of cardholder Doron Aviad.

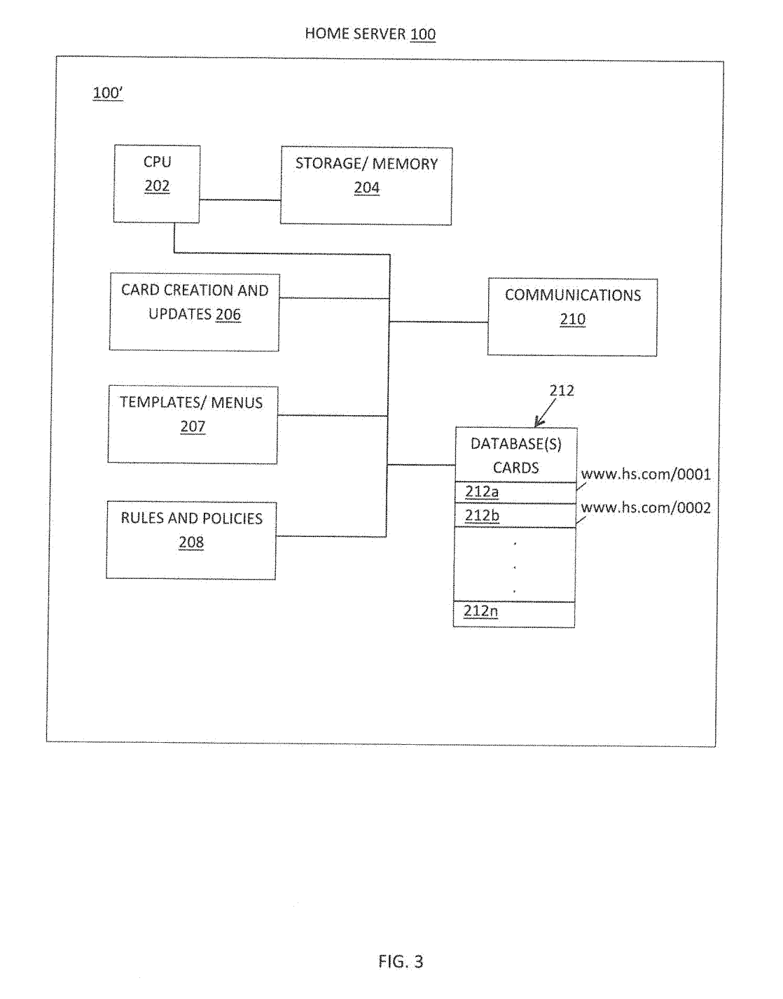

FIG. 3 shows the system 100′ of the home server 100, as an architecture. The architecture includes one or more components, engines, modules and the like, for providing numerous additional server functions and operations, and, for running the processes of the system 100′ of the invention (if the home server 100 is accessed directly), or associated with the application 102x, which maps to the home server 100, upon its being downloaded or otherwise obtained and installed, for example on each user computer 120, 130, 140. The home server (HS) 100 may be associated with additional storage, memory, caches and databases, both internal and external thereto. While a single home server (HS) 100 is shown, the home server (HS) 100 may be formed of multiple servers and/or components.

This architecture of the system 100′, as shown, for example, in the home server 100, includes a central processing unit (CPU) 202 formed of one or more processors, electronically connected, including in electronic and/or data communication with storage/memory 204, a card creation module 206 which links to templates and menus 207 in storage media via which digital cards, e.g., electronic representations thereof, are created (with these electronic representations stored in the database 212 as cards 0001 to n, and a rules and policies module 208, which stores rules and policies for the various parties who can access templates and cards 212a-212n in the database 212, to create and/or modify an electronic representation of a digital card 212a-212n. There is also a communications module 210 for facilitating communications between the home server 100, and smartphone 120, as well as the APP Server 102, User2 130, the cardholder 140 and the system administrator 142.

The Central Processing Unit (CPU) 202 is formed of one or more processors, including microprocessors, for performing the home server 100 and system 100′ functions and operations detailed herein, including controlling the card creation and updates module 206, the templates storage media 207, the rules and policies module 208, the communications module 210 and the database 212, as well as other operations detailed herein. The processors are, for example, conventional processors, including hardware processors, such as those used in servers, computers, and other computerized devices. For example, the processors may include x86 Processors from AMD and Intel, Xenon® and Pentium® processors from Intel, as well as any combinations thereof.

The storage/memory 204 is any conventional storage media. The storage/memory 204 stores machine executable instructions for execution by the CPU 202, to perform the processes of the invention.

The processors of the CPU 202 and the storage/memory 204, although shown as a single component for representative purposes, may be multiple components, and may be outside of the home server 100 and/or the system 100′, and linked to the network 50.

While the card 160 is shown with various functionalities, the system administrator 142 can also issue and remove, and set expiration times, for various access, such as to doors, parking garages, gates and elevators and other structures, from the card 160, by merely accessing the electronic representation of the card in the storage media including, for example, the database 212.

Example cards for the digital card 160 and its electronic representation in the database 212 are as follows, as they present (display) on the display screen of a user/recipient's device, such as the smartphone 120.

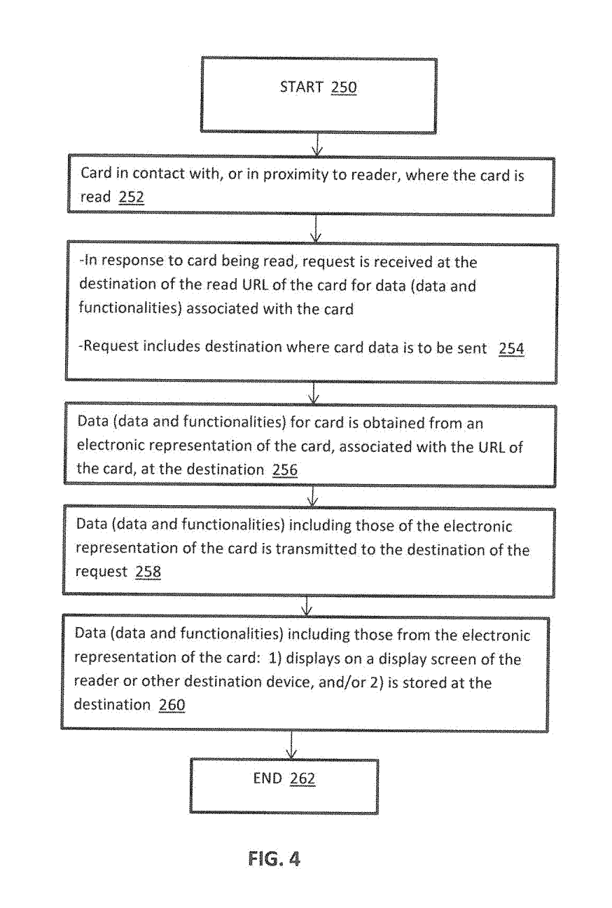

FIG. 4 is a flow diagram detailing a computer-implemented process in accordance with embodiments of the disclosed subject matter. Reference is also made to elements shown in FIGS. 1, 2A, 2B and 3. The process and sub-processes of FIG. 4 are computerized processes performed by the system 100′, as originated by a card 160 being read. The aforementioned processes and sub-processes can be, for example, performed manually, automatically, or a combination thereof, and, for example, in real time.

The process begins at a START block 250. At this block, an electronic representation of the card 160 has been created, for example, as detailed above, and is stored in storage media in the system 100′ in association with a URL unique to the card. The process moves to block 252, where the card is brought (by a user) into contact with, or in proximity of, the reader, e.g., a computerized or computer device, such as a smartphone 120, to be read, for example by near field communication. The card is read by the reader. For example, the card is read such that a unique indicator associated with the card, such as a unique URL, is read by the reader.

The process moves to block 254, where, in response to card 160 being read, a request (for example, automatically sent from the reader 120) is received at the destination of the read URL, e.g., the home server 100 of system 100′, of the card for data (data and functionalities) associated with the card. Typically, the request (from the reader 120) includes a destination where card data from the system 100′ is to be sent, but should the request not include a destination for sending by the system 100; a default, for example, is the reader from where the request was sent. Alternately, the request sent by the reader and received by the system 100′ may include additional data such as to provide a signal, visual, audio, or tactile, at the reading device or other destination, when there is data in the electronic representation of the card permitting an action, such as an entry or access to, for example, a location, entryway, door, secured area, cabinet, storage area, or the like.

Once the system 100′ receives the request from the reader (e.g., over the network(s) 50), the process moves to block 256, where data (data and functionalities) for the card is obtained (e.g., automatically) from an electronic representation of the card, associated typically with the URL of the card, at the destination. This electronic representation is typically stored data (data and functionalities), such as that in the database 212, corresponding to the requisite card. For example, for card 160, with the URL www.hs.com/0001, the electronic representation of the card is an entry/file 212a of the database 212, as it matches the URL of www.hs.com/0001, of the database entry/file 212a.

The process moves to block 258, where data (data and functionalities) including those of the electronic representation of the card is transmitted (e.g., automatically) to the destination of the request (from the reader). The process moves to block 260, where the data (data and functionalities) including those from the electronic representation of the card: 1) displays on a display screen 160x (FIG. 2B) of the reader 120 or other destination device, and/or 2) is stored at the destination, for example, a server and/or other storage media associated with the reader. The process moves to block 262, where it ends.

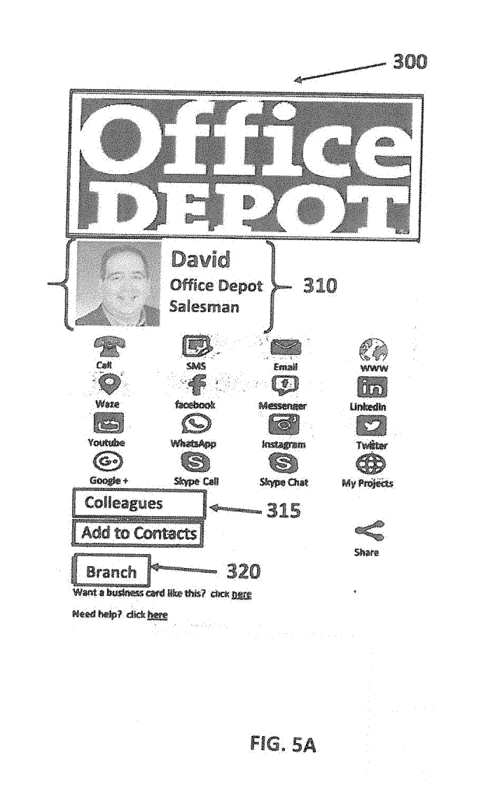

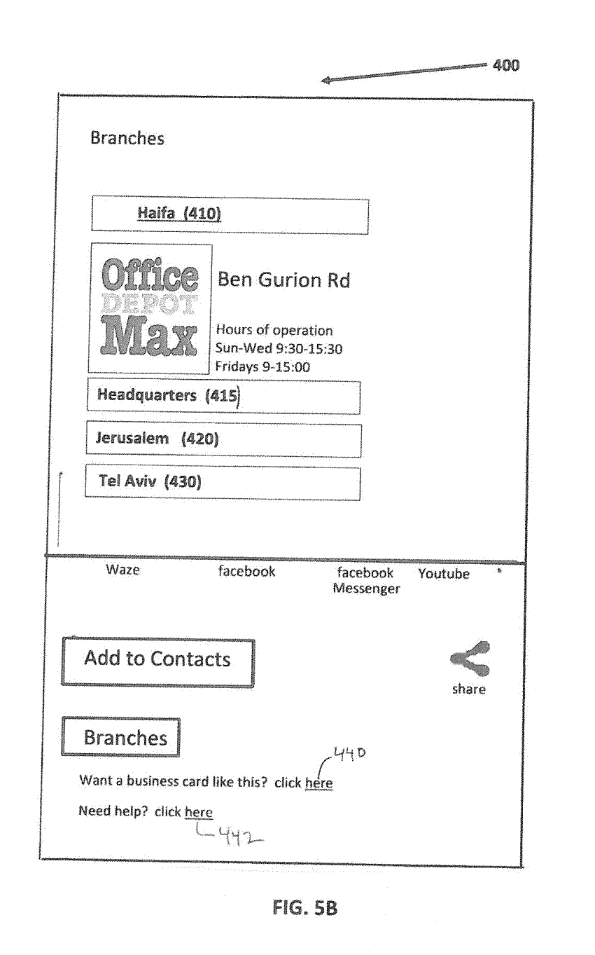

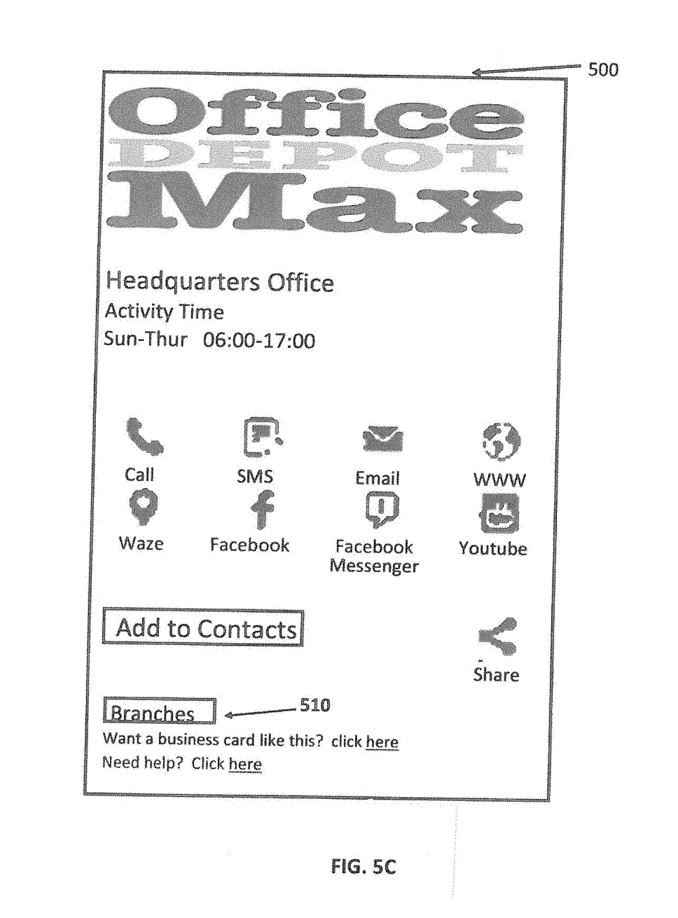

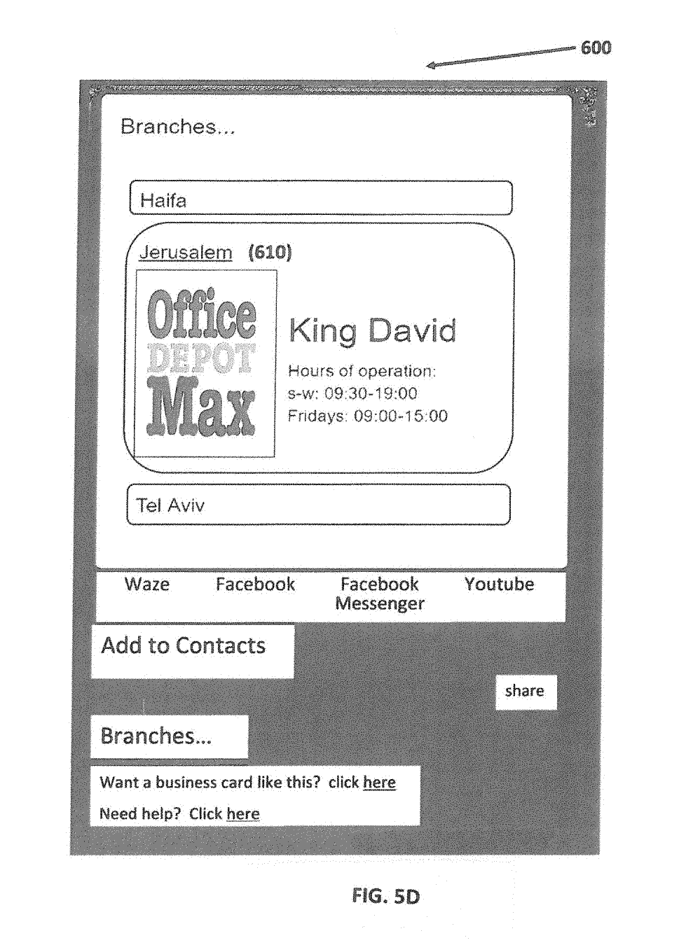

FIG. 5A is a screen diagram of a digital card 300 for David, an Office Depot salesman 310, as it displays on the screen display, e.g., touch screen of a mobile device, such as a smartphone 120. Optionally, the entity 140 who issues the digital card 300 can link the card to a branch of the company where David works. This is shown, for example, on the card 300 by an icon 320 with the word “Branch” 320. Upon activating the Branch icon 320, a card 400 for the branch where David works opens on the recipient's mobile phone, as shown in FIG. 5B. Similarly, a “Colleagues” button 315 enables the card recipient to access other salesmen, for example, when the card owner is a salesmen for a particular company. A popup appears showing many or all of the departments in the salesman's company and the recipient can access many or all the people inside each department.

FIG. 5B is a screen diagram of a digital card 400 for the branch office of Office Depot, which displays on the touchscreen of the mobile device, e.g., smartphone 120 of a user. The user, by an activation of the Haifa 410 button, can obtain information about the Haifa branch, including employees, product promotions, hours of operation, and the like. There are also other button options, such as contacting the headquarters 415, a Jerusalem Branch 420, or a Tel Aviv Branch 430. There are also hyperlinks for getting digital cards like this 440, and for help 442, when activated, by a swipe, contact, touch or the like.

Alternatively, upon clicking the Headquarters button 415, the Headquarters digital card 500 of FIG. 5C will open and display on the user's mobile phone, such as smartphone 120.

FIG. 5C is a screen diagram illustration of a Headquarters Digital Card 500 for Office Depot, as it displays on the user's smartphone, e.g., smartphone 120. When activation of the Branches Icon 510 occurs, by contact, swipe, touch or the like, the digital card of FIG. 5D displays on the touchscreen of the smartphone.

FIG. 5D is a screen diagram of the digital card 600, which presents on the touch screen of the mobile phone 120. This image for the digital card 600 appears and presents on the touch screen of the smartphone 120, when the user clicks the Jerusalem branch button 420 of the screen display for the card 400 of FIG. 5B.

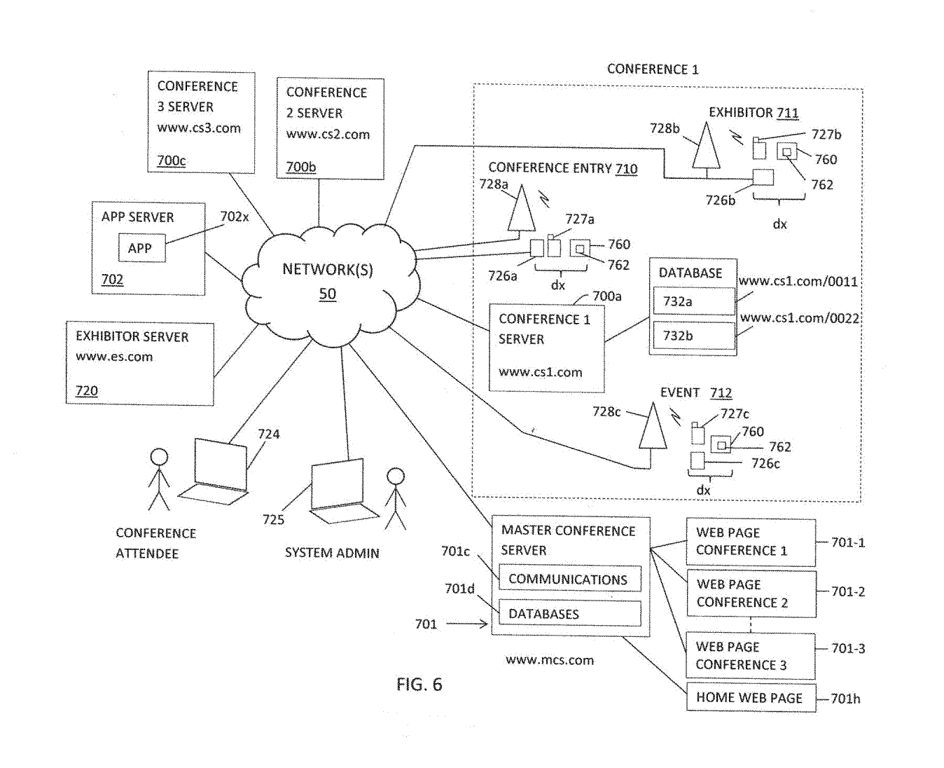

FIG. 6 shows an environment where the cards of the invention are also used, as part of a smart conference management system. The conference management system includes a network 50, in accordance with the network(s) 50 described above, as well as conference servers 700a-700c, for Conference 1 700a www.cs1.com, Conference 2 700b www.cs2.com, and Conference 3 700c www.cs3.com, linked to the network(s) 50, as well as the master conference server 701 www.mcs.com, also linked to the network(s) 50. The conference servers 700a, 700b, 700c are similar to the home server 100 and system 100′ thereof, and are in accordance with the descriptions provided for the home server 100 and system 100′ above. The master conference server 701 links to the conference servers 700a, 700b, 700b, and exchanges data therewith.

Conference 1 is representative of all conferences controlled by the master conference server 701. Accordingly, Conferences 2 and 3, which operate similarly, are not shown in detail. With representative Conference 1, a Conference Entry system 710, an Exhibitor system 711 and an Event system 712, link to the network(s).

Additionally, there is an application server 702, which supports an application (APP) 702x (similar to the application server 102 and application (APP) 102x detailed above) downloadable by the various parties to the Smart Conference System such as the Exhibitor (exhibitor system 711 and Exhibitor server 720, www.es.com), the conference attendee 724, and a system administrator 725, representative of the system administrator for the master conference server, and the servers 700a-700c for Conferences 1-3, respectively. The application server 702, exhibitor server 720, conference attendee 724 representative of all conference attendees, as well as parties interested in viewing data concerning any of Conferences 1-3, and the system administrators 725, link to the network(s) 50.

Conference server 1 700a is similar to the home server 100 and its system 100′, as it administers Conference 1, and includes a database 732, with electronic representations 732a, 732b of cards with the unique URLs of www.cs1.com/0011 and www.cs1.com/0022, respectively. At Conference 1, the conference entry 710, Exhibitor 711 and Event 712, include card readers, such as those using NFC, or magnetic readers, such as readers 726a, 726b, 726c (which link to the Network(s) 50) or computing devices such as smartphones 727a, 727b, 727c (which link to cellular towers 728a, 728b, 728c, which in turn link to the network(s) 50), for cards 760 with readable media 762, similar to that of card 160 and readable media 162, as described above. The cards 760 are read, for example, when within the distance dx, or in contact with the respective reader.

The master conference server 701 is a computer or server for administering all of the conferences (Conferences 1-3). The server 701 includes communications modules 701c and databases 701d, and hosts web pages, over which a conference attendee can register for a conference, modify or cancel their registration for a conference, or view attendees and other information about a conference. The hosted web pages include a home page 701h for all of the conferences (Conferences 1-3), as well as web pages for Conference 1 701-1, Conference 2 701-2 and Conference 3 701-3.

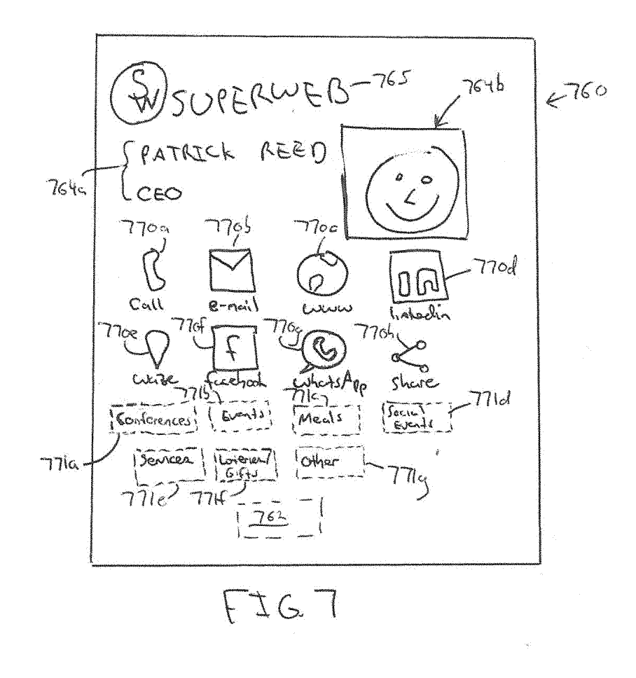

FIG. 7 shows the card 760 with a readable media 762, similar to that of the card 160 and readable media 162. The card 760 is assigned the unique URL www.cs1.com/0011, which is associated with the electronic representation of the card 760 in the database 732, and database entry/file 732a (e.g., based on matching associated URLs). The card 760 and the Conference Entry 710, Exhibitor 711 and Event 712 operate in accordance with the processes detailed above for FIGS. 1-4, with differences in operated noted.

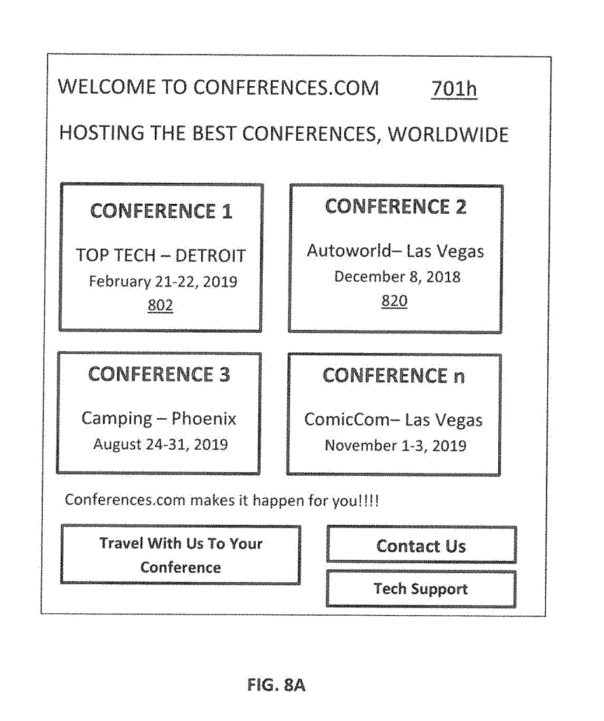

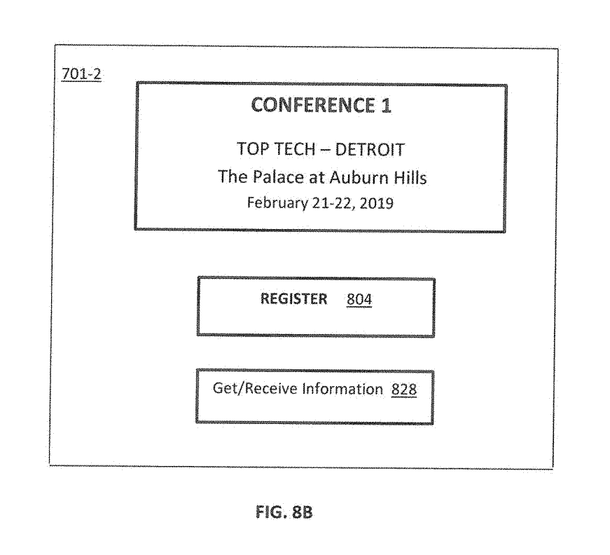

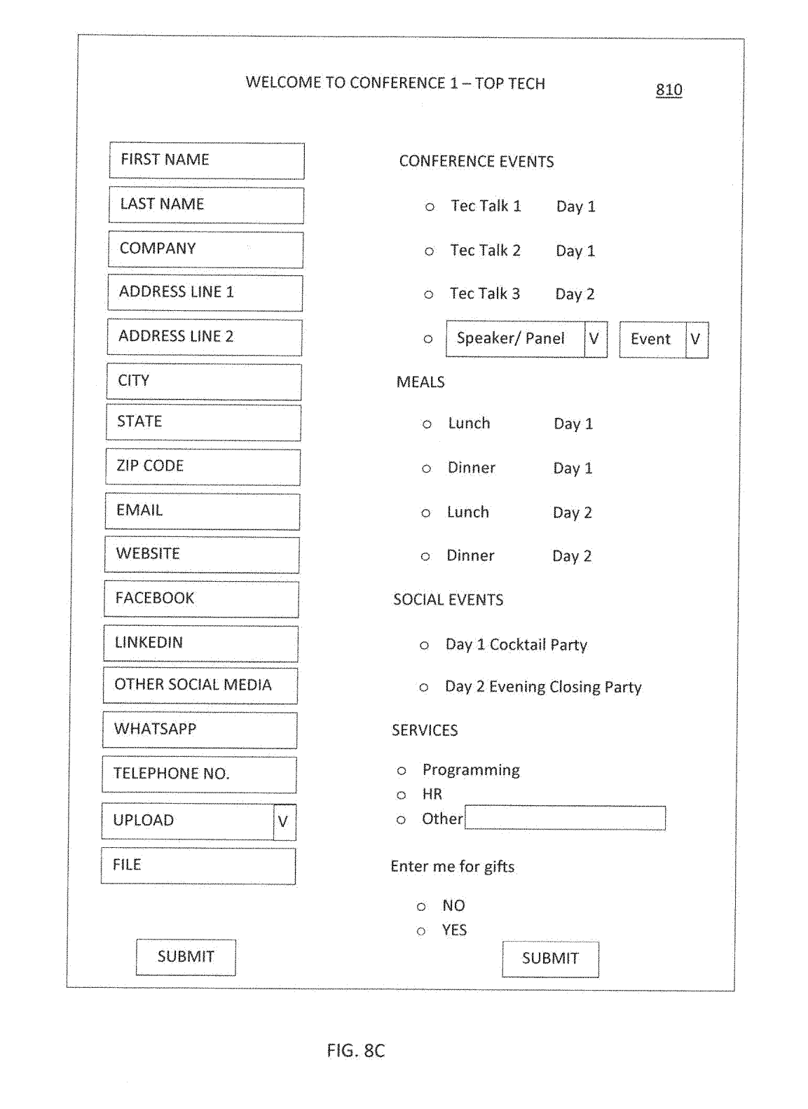

The electronic representation of the card includes data and functionalities inputted by the conference attendee 724 into the Conference 1 data input web page 810 of FIG. 8C (with the data, e.g., data and functionalities detailed above). The attendee 724 arrives at the Conference 1 data input web page 810, via the Conferences home page 701h, of FIG. 8A, and then by clicking on the “Conference 1—Top Tech” button 802, arrives at the Conference 1 home page 701-1 of FIG. 8B. By clicking on the button “Register” 804, the attendee's browser is directed to the Conference 1 data input web page 810, as shown in FIG. 8C, where he inputs data into fields, selects options, uploads photos, graphics, files, and the like, and selects from various drop-down menus, so as to form an electronic representations (database file 732) of his card 760. The aforementioned input or portions thereof may also be preprogrammed into the conference server 701. The electronic representations of the cards from the conference server 701, are transmitted to and shared with the Conference 1 server 700a, the server for the attendee's 724 specific conference.

The card 760 is associated with the URL www.cs 1.com/0011, associated with the Conference 1 Server 701a, and is stored in a database 732 in the Conference 1 server 700a (as well as the main conference server 701) as an electronic representation (database entry/file) 732a of the card 760. The card 760 includes information and data about the subject of the card 764a and an image of the holder 764b, the affiliation of the holder 765, e.g., Superweb, and various functionalities 770. These functionalities include, for example, actions such as CALL, represented by icon 770a, email 770b, web access 770c, linked in profile for Patrick Reed, 770d, Waze™ (get directions to Patrick Reed's location 770e, access Patrick Reed's Facebook Page 170f, send Patrick Reed a WhatsApp message 770g, and share a digital media item with Patrick Reed 770g. The card 760 is also coded (as represented in broken line boxes) to show the conferences he is registered for 771a, e.g., Conference 1, and events he will be attending at the conference 771b, including whether he will be a speaker, panelist, moderator or an attendee 1, the meals he has paid for 771c, any social events he has entry privileges 771d, any services 771e he has paid for, any lotteries drawings for gifts he has entered 771f, and any other information 771e, such as wheelchair access he may need.

For example, when Patrick Reed's card is read at the Conference 1 entry point 710, the reader 726a, 727a sends the Conference 1 server 700a a request for the data of the electronic representation of the card 760, to see whether Patrick Reed is permitted to enter the conference, e.g., Conference 1. As Patrick Reed is permitted to enter Conference 1 (as indicated by box 771a), the Conference 1 server 700a sends back a signal, which may be a sound or visible indicator on the reader 726a, 727a, that Patrick Reed may enter Conference 1. The Conference 1 server 700a, as well as the main conference server 701 will store the data that Patrick Reed attended Conference 1 on Day 1.

When Patrick Reed passes the booth of the Exhibitor 711, and allows his card 760 to be read, by either of the readers 726b, 727b, a request is sent to the Conference 1 Server 700a, to provide the data (data and functionalities) of the electronic representation of the card to the reader 726b, 727b, or to a destination designated by the request, such as the Exhibitor's Server 720, where the data for the card of Patrick Reed is stored. The Conference 1 sever 700a transmits the data (data and functionalities) of the electronic representation of the card to the reader 726b, 727b, or to a destination designated by the request. This allows the Exhibitor to store information on all people who made contact with the Exhibitor at the Conference (Conference 1—Top Tech). Additionally, data is sent to the main conference server 701 (as well as stored in the Conference 1 server 700a), that Patrick Reed contacted the Exhibitor. Alternately, the readers 726b, 727b can store the URLs read from the readable media 762 of the card 760, and should the readers be off-line or the network down, the readers 726b, 727b will resume operation, transmitting the request to the destination of the card URL, when the reader 726b, 727b goes back on line or network service resumes.

For example, when Patrick Reed's card is read at the Event entry point 712, for example, for Tech Talk 1, for which he has registered, the reader 726c, 727c sends the Conference 1 server 700a a request for the data of the electronic representation of the card 760, to see whether Patrick Reed is permitted to enter the Event, e.g., Tech Talk 1. The system 100′ matches the URLs associated with the card and database entry/file with the electronic representation of the card, and checks whether the electronic representation of other data of the database entry/file has an indication that Patrick Reed (the cardholder) may enter the particular event, such as Event 712. With there being data that Patrick Reed is permitted to enter the Event (as indicated by box 771b, for example, as a speaker), the Conference 1 server 700a sends back a signal (in accordance with the request), which may be a sound or visible indicator on the reader 726c, 727c, that Patrick Reed may enter the Event. The Conference 1 server 700a, as well as the main conference server 701 will store the data that Patrick Reed attended the Event, e.g., Tech Talk 1 as a speaker.

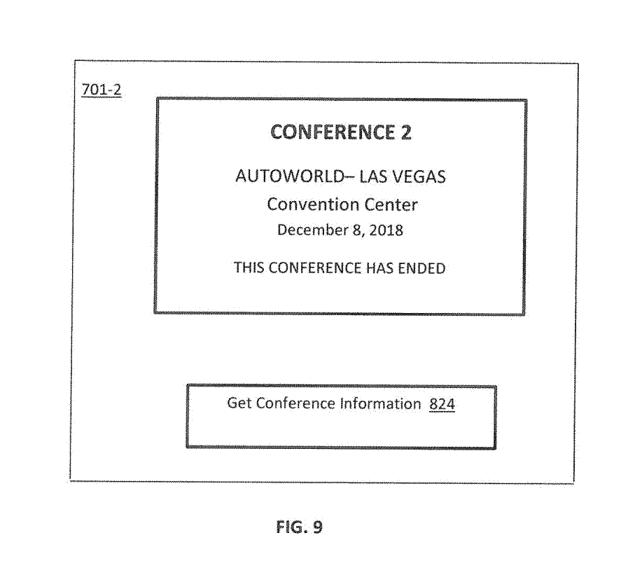

Turning back to FIG. 8A, the conferences home page 701h may be accessed by a user 724, who may want to see who attended Conference 2, as Conference 2 is over. The user 724 clicks on the “Conference 2—Autoworld” button 820, and is directed to the Conference 2 web page 701-2, of FIG. 9. By clicking on the “Get Conference Information” button 824, the user's 724 browser is directed to the Conference 2 server 701b, where the user 724 may obtain the information he requested.

Also in FIG. 8A, the user 724 may want information on Conference 1, which is in the future. The user 724 clicks on the “Conference 1—Top Tech” button 810, and is directed to the Conference 1 web page 701-1, of FIG. 8B. By clicking on the “Information” button 828, the user's 724 browser is directed to the Conference 1 server 701a, where the user 724 may obtain the information about the conference, which may include attendees, speakers, events, and the like.

Finally, additional information, such as a conference attendees desire to be entered into a lottery, sweepstakes or other event to receive gifts, prizes and the like, may be obtained from a pool of attendees to an event, who are indicated as attending or having the attended a conference or event therein. By using the data obtained from cards of attendees, a winning attendee may be selected and contacted, so he can claim his prize.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for transferring data to a computerized location comprising:
providing a physical apparatus including readable media including a readable indicator, the indicator associated with a system destination;
in response to the readable media of the physical apparatus being read, receiving a request for data at the system destination associated with the indicator;
obtaining data for the request by accessing an electronic representation of the physical apparatus associated with the indicator at the system destination; and,
transmitting the data of the electronic representation to a request destination provided in the system request.

2. The method of claim 1, wherein the physical apparatus includes a card.

3. The method of claim 1, wherein the readable indicator includes a uniform resource locator (URL).

4. The method of claim 2, wherein the readable indicator includes the system request.

5. The method of claim 2, wherein the system destination includes a computer configured for administering the card.

6. The method of claim 2, wherein the request destination includes a device which reads the card.

7. The method of claim 6, wherein the device includes a smart phone and the data of the electronic representation transmitted to the device displays on the device such that the user of the device can cause the displayed data to be stored in the device, or at another location linked to the device.

8. The method of claim 2, wherein the request destination is a location different than the device which read the card.

9. The method of claim 5, wherein the electronic representation of the card is stored in storage media associated with the computer configured for administering the card.

10. The method of claim 3, wherein the URL maps to a computer configured for administering the physical apparatus, the computer defining the system destination.

11. The method of claim 1, wherein the electronic representation of the physical apparatus includes data and functionalities.

12. The method of claim 1, wherein the readable media of the physical apparatus is read by at least one of near field communications (NFC), radio frequency (RF), magnetics and light.

13. The method of claim 1, wherein the readable media includes one or more of chips, magnetic components, Radio Frequency chips, and light activatable chips.

14. The method of claim 1, wherein the readable media includes the indicator and/or the system request coded therein.

15. The method of claim 1, additionally comprising: receiving input of data including data and/or functionalities for creating the electronic representation of the physical media.

16. The method of claim 1, wherein the obtaining the data and transmitting the data are performed automatically.

17. A system for transferring data to a computerized location comprising:
a card including readable media including a readable indicator, the indicator associated with a system destination; and,
a computer defining the system destination for administering the card, the computer configured for:
receiving a request for data at the system destination associated with the indicator, in response to the readable media of the card being read;
obtaining data for the request by accessing an electronic representation of the card associated with the indicator at the system destination; and,
transmitting the data of the electronic representation to a request destination provided in the system request.

18. The system of claim 17, wherein the readable indicator includes a uniform resource locator (URL) and/or a request coded into the readable media of the card.

19. The system of claim 17, wherein the readable media of the card is read by at least one of near field communications (NFC), radio frequency (RF), magnetics and light.

20. The system of claim 17, wherein the readable media includes one or more of chips, magnetic components, Radio Frequency chips, and light activatable chips.
